(19) United States
(12) Patent Application Publication
(10) Pub. No.: US 2018/0290823 A1
(43) Pub. Date: Oct. 11, 2018

(54) CAPSULE CUP OF A COFFEE CAPSULE

(71) Applicant: MÜHLEMANN IP GMBH, Stein am Rhein (CH)

(72) Inventor: Rolf MÜHLEMANN, Schlattingen (CH)

(73) Assignee: MÜHLEMANN IP GMBH, Stein am Rhein (CH)

(21) Appl. No.: 16/062,262

(22) PCT Filed: Dec. 15, 2016
(86) PCT No.: PCT/EP2016/081319

§ 371 Date: Jun. 14, 2018

(30) Foreign Application Priority Data
Dec. 16, 2015 (EP) 15200540.1

(51) Int. Cl. B65D 85/804; A47J 31/36

(52) U.S. Cl. CPC B65D 85/8043; A47J 31/3628

(57) ABSTRACT

A plastics-material capsule casing which, by virtue of its shaping, undergoes hardly any deformation during the extraction operation and provides for improved penetration of the injection needles of the extraction machine. The capsule casing has a corresponding conical lateral-surface wall which, at the upper periphery, has an outwardly projecting flange and, at the opposite end, is fully closed by a casing floor. The casing floor has a peripheral annular wall which merges from the conical lateral-surface wall via two opposing curvatures in an annular wall. The lower periphery of the annular wall merges into a panel via a thinned region which runs in an inclined manner in relation to the interior. The central panel has a wall thickness corresponding to the wall thickness of the lateral-surface wall. The thinned annular surface here forms an injection membrane.

### TECHNICAL FIELD

The present invention relates to a capsule cup for producing a coffee capsule, which is used in an extraction cup of an extraction coffee machine and is correspondingly shaped such that it is received in the extraction cup of the extraction coffee machine.

Such coffee capsules consist of a capsule cup, into which a predetermined quantity of ground coffee is filled and which is then closed by means of an aluminium foil which is welded onto a flange of the coffee capsule on an extraction side.

The most widespread coffee capsule of this type is distributed worldwide by Nestlé SA under the protected trademark Nespresso®. Extraction coffee machines which are suitable for these coffee capsules are included amongst the most widely distributed extraction coffee machines and these machines are also supplied under the protected trademark Nespresso®. Therefore it is not surprising that a plurality of coffee capsules which are designed to be compatible with these extraction coffee machines are now available on the market.

### PRIOR ART

The majority of all coffee capsules which are available today on the market all have a substantially similar external design, as is disclosed already in the U.S. Pat. No. 4,136,202. Whilst the original Nespresso® capsules are made of aluminium, as before, the compatible imitation capsules are produced from plastics. These known coffee capsules have a substantially conical outer wall, a peripheral flange being arranged on the upper cup edge thereof and the cup bottom thereof being fully closed. The design of the capsule cups has to be adapted to the extraction coffee machines. These machines have an extraction cup in which the coffee capsule is held during the extraction operation, and as a result the capsule cups have to be adapted as accurately as possible to the shape of the extraction cups in the extraction coffee machines.

Whilst originally the injection of water was introduced by a single injection needle centrally through the cup bottom, today this takes place by means of three injection needles arranged at equal distances around the centre. This type of water injection ensures an improved water flow which flows entirely through the capsule space.

In capsule cups produced from plastics by injection-moulding technology, solutions brought to the market were initially limited to those in which the bottom of the capsule cup did not have to be perforated. Such solutions are preferred, on the one hand, for reasons relating to patent law, but, on the other hand, also since it was feared that the hot injection needles could be blocked by contact with the plastics or at least be bonded thereto if said plastics came into contact with the hot injection needles. Accordingly, different variants have been provided in which the bottom of the capsule cup was already provided with prefabricated holes. These variants, however, had to have a gas-tight packaging made of aluminium-coated plastics films which ensure aroma protection. In a subsequent step, capsule cups appeared on the market which were fully closed. Such a solution is disclosed, for example, in WO 2012/137052, in which raised projections are provided on the capsule cup which are at least partially surrounded by predetermined breaking lines and are opened when the capsule cup is pressed into the extraction cup of the machine.

Today, however, a plurality of rotationally symmetrical capsule cups which have a fully closed cup bottom are on the market. Here they are capsule cups which are produced from plastic and which have a slightly higher softening temperature range, so that the risk of the plastics melting onto the injection needles no longer occurs when the bottom of the capsule cups is penetrated.

In practice, the design of the bottom of the capsule cups may be reduced to two variants. The one version provides an entirely planar design of the cup bottom whilst the other version discloses a convex outwardly bulged shape of the cup bottom. The first version is disclosed, for example, in EP 512 468, whilst the second version is disclosed, for example, in EP 554 469. Both versions are completely unproblematical in capsule cups which are produced from aluminium. In versions which are produced from plastics, however, both versions are very problematical. When heating the capsule cup made of plastics, this capsule cup already becomes soft and deforms even when a small amount of force is introduced, as occurs with the introduction of the injection needle. As a result, the bottom of the capsule cup yields with the pressure of the needle and bulges inwardly so that consequently the bottom is often insufficiently penetrated or in some areas the bottom is not fully penetrated by the injection needles. This has the result that the extraction operation in the capsule only takes place unsatisfactorily and the coffee tastes correspondingly watery. Additionally, a portion of the hot water passes outside the capsule cup into the extraction cup of the extraction coffee machine. As a result of this effect, the capsule cups had to be provided with seals.

### OBJECT OF THE INVENTION

It is, therefore, the object of the present invention to provide a capsule cup according to the preamble of claim 1 which ensures an improved penetration of the injection needles through the cup bottom of a capsule cup produced from plastics.

This object is achieved by a capsule cup having the features of claim 1. The capsule cup has a peripheral outwardly oriented annular wall, the cup bottom being integrally formed thereon and said cup bottom having a circular plate which is offset inwardly relative to the annular wall and which is connected to the annular wall via an inwardly inclined annular surface, wherein the annular surface is thinned relative to the annular wall and the plate and thus forms an injection membrane.

The capsule cups produced from aluminium are in practice rigid and have a plastic behaviour. If the shape of a capsule cup disclosed in EP 554 469 is considered, here the cup bottom is subsequently formed on the conical outer wall by a conical annular surface which is inclined toward the centre and to which a small planar bottom plate is adjoined in the centre. This shape in an embodiment made of aluminium reinforces the cup bottom in the region in which the injection needles penetrate, namely in the conical annular surface of the cup bottom. In a version made of plastics, however, this is not in any way appropriate. Here by heating and softening the material under pressure, in practice this outwardly bulged cup bottom shape springs inwardly and thus away from the injection needles. This leads to the above-described phenomenon that the injection needles are not ultimately guided through the cup bottom or not fully guided through the cup bottom. Only when at least some of the injection needles are guided fully through the cup bottom is an increased pressure temporarily created in the capsule which then perforates, as desired, the outwardly bulged aluminium film which is welded to the flange and the actual extraction operation is able to take place. When creating the internal pressure, with a capsule cup made of plastics, it may occur that the conical annular surface bulges outwardly again by the pressure created and the injection needles which have not previously penetrated therein or only incompletely, are then able to penetrate therein fully. If, however, too much water and steam penetrates the region between the extraction cup of the coffee extraction machine and the outer face of the coffee capsule, the pressure thus created in the extraction cup cancels out the internal pressure in the capsule cup and the cup bottom is not able to spring back into the convex initial shape. Due to the design of the capsule cup according to the invention, the previously disclosed alteration to the shape of the bottom of the capsule cup is not able to take place. The shape has in practice anticipated this shape alteration. A further deformation is not possible.

Further particularly preferred features of the subject of the invention are disclosed in the dependent claims and the meaning thereof is described in the following description with reference to the accompanying drawings.

In the drawings, a preferred embodiment of the subject according to the invention is shown, in which:

FIG. 1 shows a diametrical vertical section through a preferred embodiment of the capsule cup,

FIG. 2 shows a partial section through the cup bottom in an enlarged scale and

FIG. 3 shows a view from above into the interior of the capsule cup in a smaller scale than the diametrical section according to FIG. 1.

### BRIEF DESCRIPTION OF THE DRAWINGS

The capsule cup shown in FIG. 1 is denoted as a whole by 1. The capsule cup 1 is substantially formed by a conical outer wall 2 which at the upper edge terminates in an outwardly protruding flange 3. This flange 3 serves primarily to weld a plastics or aluminium film thereto, sealing the capsule cup. Secondly, in the coffee extraction machine this flange serves to hold the capsule cup clamped in the exact position. The design of the flange 3 naturally has to be shaped so as to be adapted to the extraction cup on the machine side.

At its tapered end, the capsule cup is closed by the cup bottom 4. The cup bottom 4 has no openings but is perforated only by the injection needles on the machine side during the use thereof.

The cup bottom is delimited on the periphery by a peripheral annular wall 5. The height of the peripheral annular wall is 0.5-4 mm, but preferably between 2 and 3.5 mm. The annular wall 5 which is oriented vertically downward, upward or downward and upward relative to the lower edge 9 of the outer wall 2 parallel to the rotational axis, forms a reinforcement of the cup bottom 4. The actual cup bottom has two regions, namely, on the one hand, a central circular plate 6 and, on the other hand, an integral, adjacent peripheral annular surface 7 which is inclined toward the cup interior and which in turn is integrally connected to the annular wall 5. The wall thickness of the annular surface 7 is less than the thickness of the plate 6 and also less than the wall thickness of the annular wall 5. This annular surface 7 forms an injection membrane. The term “injection membrane” is intended to indicate, on the one hand, the low wall thickness of the annular surface 7, whilst the term, on the other hand, indicates that this membrane is arranged where the injection needles on the machine side puncture the cup bottom 4 of the capsule cup 1. The annular surface 7 is dimensioned to be sufficiently wide that, even with the permitted and possible deviations of the centre of the capsule cup in the retained position in the extraction cup, the injection needles are still located in this region of the annular surface 7.

The annular surface 7 is always attached to the annular wall 5. This may take place at any height of the annular wall 5. In FIG. 4, the various possibilities are shown schematically. All partial sections of the FIGS. 4 extend diametrically but in contrast to FIG. 1 do not extend through a support lamella 13, 13′ but between two support lamellas 13, 13′. FIG. 4C shows a solution which corresponds to the embodiment according to FIG. 1. Here the annular surface 7 is attached as already described above to the lower edge 8 of the annular wall 5. The annular surface 7, however, may also be attached at any intermediate height to the annular wall 5, as shown in FIG. 4B, and finally the annular surface 7 may also be attached to the annular wall 5 at the bottom of the annular wall 5, wherein in practice this is located at the height of the lower edge 9 of the outer wall 2. FIG. 4A shows this solution.

However, it is necessary that, from the attachment point on the annular wall 5 toward the plate 6, the annular surface 7 always extends at a negative angle a to the interior 20 of the capsule cup 1. This negative angle is generally of a size of between 5° and 30° depending on the height difference between the attachment point of the annular surface 7 on the plate 6.

In FIGS. 4D-4F, the annular wall 5 is offset relative to the lower edge 9 of the side wall 2 of the capsule cup 1 such that the annular wall extends from the lower edge 9 of the side wall 2 both upwardly into the interior 20 of the capsule cup 1 and downwardly relative to the attachment point on the side wall 2. Also here the annular surface 7 may be attached to the annular wall 5 at different heights, as FIGS. 4D-F show.

FIGS. 4G to 4I show finally the variant in which, from the attachment point at the lowermost edge 9 of the side wall 2, the annular wall 5 is oriented fully into the interior 20. Once again, the attachment point of the annular surface 7 which forms the connection with the plate 6 may be formed at different heights on the annular wall 5, namely at the uppermost point (FIG. 4G) or lowermost point (FIG. 4I) or therebetween (FIG. 4H).

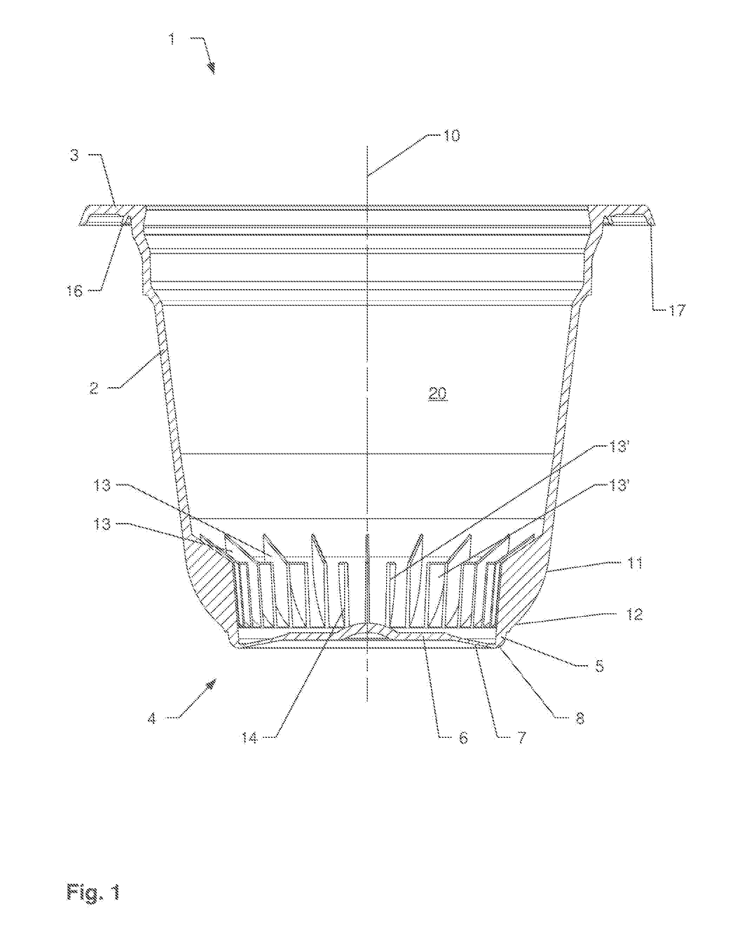

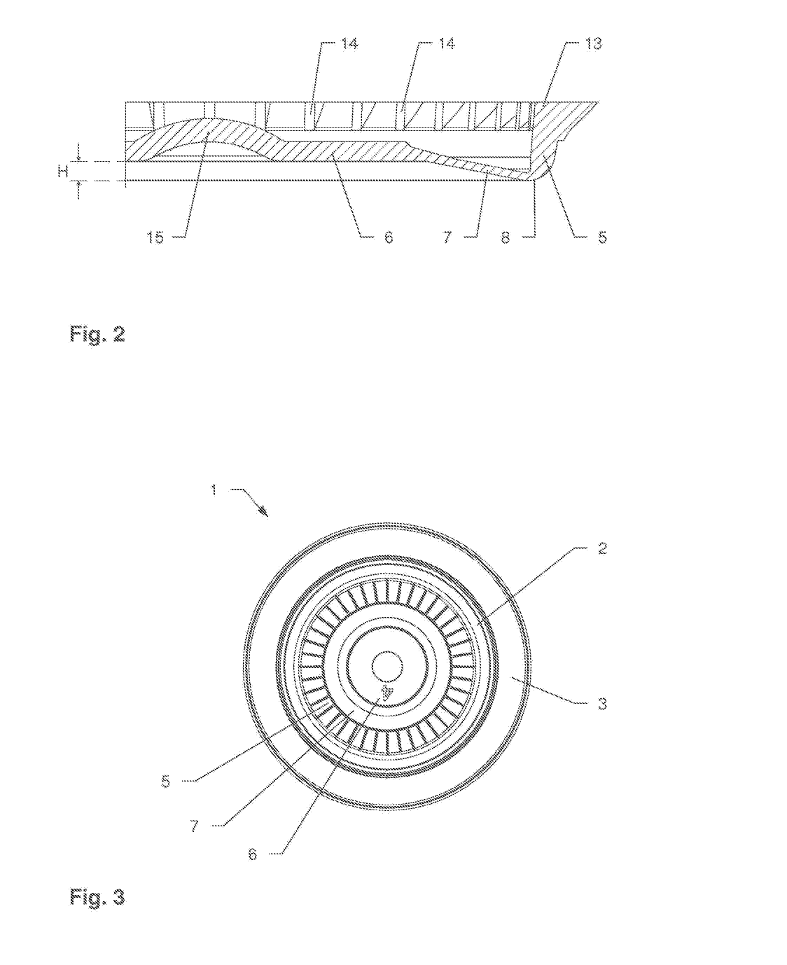

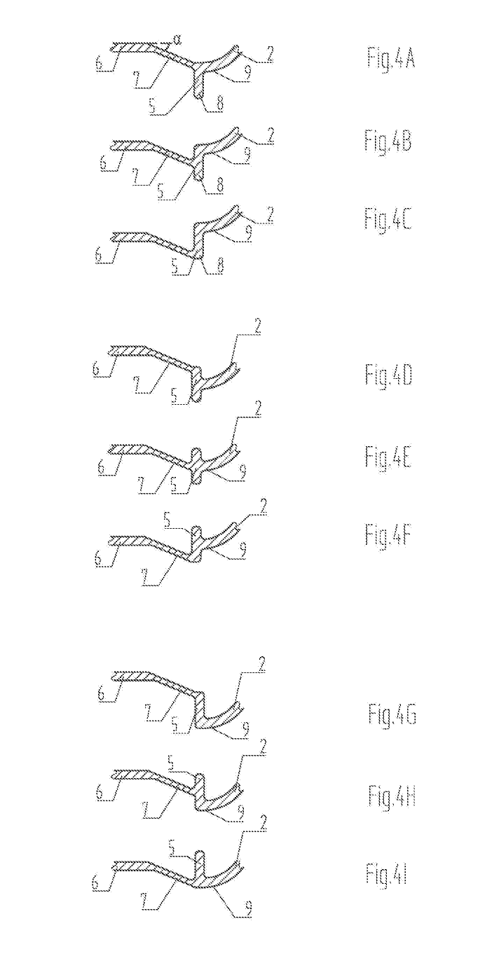

The plate 6 of the cup bottom 4 is offset relative to the lower edge 8 of the annular wall 5 by a height H of 0.3 to 1.0 mm toward the interior. Both the lower edge 8 of the annular wall 5 and the plate 6 extend in parallel planes, which in turn extend parallel to the plane in which the flange 3 extends and perpendicular to the axis of symmetry 10 of the capsule cup 1.

The conical outer wall 2 of the capsule cup 1, preferably but not necessarily, merges directly with the annular wall 5 in two opposing curvatures 11, 12. In this region, a plurality of support lamellas 13 are arranged in the interior of the capsule cup 1. The support lamellas 13 are defined toward the centre by front edges 14. These front edges extend at least approximately parallel to the axis of symmetry 10. The front edges 14, aligned with the internal surface of the peripheral annular wall, merge directly therewith. Thus the introduction of a pressure force on the lower edge of the annular wall 8 is optimally introduced via the support lamellas 13 into the outer wall 2 of the capsule cup 1. The exact shape of the support lamellas is clearest in the lamellas in diametrical section. In the support lamellas, all of the front edges 14 are of the same length. With the peripheral attachment of these support lamellas to the outer wall 2, alternately the first support lamellas 13′ only extend as far as the height of the merging of the conical outer wall 2 with the two opposing curvatures 11, 12 which merge with the peripheral annular wall 5. The other support lamellas 13 face in the direction of the flange, inclined upwardly, and extend into the region of the conical outer wall 2.

As already mentioned, the capsule cup 1 is injection-moulded from plastics. In a conventional injection-moulding process, in principle, the injection nozzle of the injection-mould may discharge at any point into the cavity in which the capsule cup 1 is shaped. In this case, however, preferably the capsule cup 1 is produced by means of co-injection and provided with a barrier layer. In a co-injection method, flow paths of generally the same length should be present if possible at all points in the entire cavity, away from the injection point, in order not to damage the barrier layer. This requirement in the case of a rotationally symmetrical body, as that of the present capsule cup, is provided when the injection nozzle outlet is located in the rotational axis of symmetry. The injection nozzle outlet in this case protrudes into an injection nozzle recess 15.

The invention further relates to an injection-mould which is suitable for producing the capsule cups made of plastics according to the invention. Such an injection-mould generally has at least one cavity which corresponds to the negative shape of the capsule cup 1. Preferably, such an injection-mould is intended to be provided with a co-injection nozzle in order to produce by co-injection the capsule cup provided with a barrier layer.

Due to its shape, the capsule cup according to the invention is still dimensionally stable even when the capsule cup is correspondingly heated in the relatively hot extraction cup of the coffee extraction machine. In particular, the annular surface 7 which forms the injection membrane 7 is in practice barely able to deform. The injection membrane 7 is in a continuously tensioned position between the plate 6 and the lower edge of the annular wall 5. With the penetration of the injection needles, in practice this annular surface does not deform and only when a pressure is created in the capsule cup is the plate 6 able to be slightly lifted under this created internal pressure which, however, merely results in all of the injection needles penetrating the capsule cup 1 to an equal depth. In contrast to the current capsule cups with an outwardly bulged bottom, which are usual and known, the inwardly oriented deformation which occurs under pressure is thus already anticipated in practice and therefore is no longer able to take place. Thus the perforation of the annular surface which is designed as an injection membrane is always uniform.

As both the wall thickness of the conical outer wall, the wall thickness of the annular wall and the thickness of the plate are at least approximately equal, it is achieved, on the one hand, that a capsule cup is produced which is as dimensionally stable as possible and, on the other hand, a flow movement which is as uniform as possible is present during the production of the capsule cup which is particularly optimal for production with a barrier layer. Only the annular surface 7 which forms the injection membrane and the support lamellas 13, 13′ have a smaller wall thickness. Preferably, the wall thickness, in particular of the annular surface serving as an injection membrane, has a wall thickness which corresponds to a maximum of half of the wall thickness of the outer wall of the annular wall and the thickness of the plate. Merely for the sake of completeness, it should also be mentioned that here, as in the majority of capsule cups, a peripheral sealing lip may be provided on the surface of the flange 3 located in the direction of the cup bottom, said sealing lip sealing the capsule cup relative to the extraction cup of the coffee extraction machine. The peripheral edge of the flange 3 has an edge 17 angled-back toward the cup bottom 4 or has a sealing bead which serves for centring and clamping the capsule cup 1 in the extraction cup of the extraction machine.

### LIST OF REFERENCE NUMERALS

1 Capsule cup
2 Conical outer wall
3 Flange
4 Cup bottom
5 Peripheral annular wall
6 Plate
7 Annular surface
8 Lower edge of annular wall
9 Lower edge of outer wall 2
10 Axis of symmetry
11, 12 Two opposing curvatures
13 Support lamellas
13′ Shorter support lamellas
14 Front edges of support lamellas
15 Co-injection nozzle recess
17 Angled-back edge of flange 3
20 Interior

1. A rotationally symmetrical capsule cup made of plastics adapted to the shape of an extraction cup of an extraction coffee machine with a plurality of injection nozzles and produced by injection-moulding technology, having a substantially conical outer wall, a peripheral flange being integrally formed on the upper cup edge thereof, and a cup bottom which is fully closed, wherein the cup bottom has a peripheral annular wall extending parallel to the axis of symmetry, the cup bottom being integrally formed thereon and said cup bottom having a circular plate which is offset inwardly relative to the annular wall and which is connected to the annular wall via an annular surface inclined toward the cup interior, wherein the annular surface is thinned relative to the annular wall and the plate and forms an injection membrane.

2. The capsule cup made of plastics according to claim 1, wherein the annular wall extends from an attachment point on the lowermost edge of the side wall downwardly, upwardly or downwardly and upwardly.

3. The capsule cup made of plastics according to claim 2, wherein the annular surface is integrally formed on the annular wall at the lowermost point, at the uppermost point or therebetween.

4. The capsule cup made of plastics according to claim 1, wherein the conical outer wall of the capsule cup merges with the annular wall in two opposing curvatures.

5. The capsule cup made of plastics according to claim 1, wherein a plurality of radially extending support lamellas, which are arranged in the interior of the capsule cup and which are oriented toward the rotational axis, are present in the transition region from the conical outer wall to the annular wall.

6. The capsule cup made of plastics according to claim 5, wherein the inwardly oriented defining edges of the support lamellas are aligned with the internal surface of the annular wall.

7. The capsule cup made of plastics according to claim 1, wherein the wall thickness of the conical outer wall, the wall thickness of the annular wall and the thickness of the plate are at least approximately equal.

8. The capsule cup made of plastics according to claim 5, wherein the wall thickness of the support lamellas is a maximum of half of the wall thickness of the outer wall 93.

9. The capsule cup made of plastics according to claim 1, wherein the capsule cup is injection-moulded coaxially with a barrier layer.

10. An injection-mould which has at least one cavity and which is designed such that said cavity defines a capsule cup according to claim 1.

11. The injection-mould according to claim 10, wherein said injection-mould is provided with a co-injection nozzle which discharges into the centre of the cavity region defined by the plate.
